(19) United States
(12) Patent Application Publication
(10) Pub. No.: US 2016/0249584 A1
(43) Pub. Date: Sep. 1, 2016

(54) PET FEEDING APPARATUS

(71) Applicant: Doskocil Manufacturing Company, Inc, Arlington, TX (US)

(72) Inventors: Zeng YIBAO, Tanzhou Zhongs (CN); Yang TIANLE, Thanzhou Zhongs (CN); Jack W. RENFORTH, Azle, TX (US)

(21) Appl. No.: 15/053,270

(22) Filed: Feb. 25, 2016

Related U.S. Application Data
(60) Provisional application No. 62/121,205, filed on Feb. 26, 2015.

(51) Int. Cl. A01K 5/00; A01K 7/00

(52) U.S. Cl. CPC A01K 5/00; A01K 7/00

(57) ABSTRACT

A pet feeding apparatus includes an enclosure, a bowl and a container. The enclosure has a first portion and a second portion, is movable between a closed state and an open state, and has an interior region disposed generally between the first and second portions in the closed state. The bowl is disposed within the interior region and configured to be movable between a collapsed configuration when the enclosure is in the closed state and a deployed configuration when the enclosure is in the open state. The container is affixed to the first portion and having an internal region configured to retain object therein, the container having an opening that is in communication with the storage region, the container being movable between a first state that permits the object to be received through the opening and a second state that resists movement of the object through the opening.

### CROSS-REFERENCE TO RELATED APPLICATIONS

This application claims priority to U.S. Provisional Application No. 62/121,205, filed Feb. 26, 2015, the contents of which is hereby incorporation herein by reference.

### BACKGROUND

1. Field of Invention

The patent or application file contains at least one drawing executed in Copies of this patent or patent application publication with color drawing(s) will be provided by the Office upon request and payment of the necessary fee.

2. Background of the Invention

Companion pets such as dogs, cats, and the like are typically fed and watered using known bowls and other containers. Many such containers are generally rigid, i.e., are formed of relatively heavy and rigid materials such as hard plastic, steel, ceramic materials etc., and thus can be inconvenient to take along when traveling with the animal. Moreover, such bowls often include food residue and/or water residue and/or animal saliva. If such bowls are desired to be removed from the home for travel, such residue and saliva typically is desirably removed in order to avoid contaminating other things with such residue and saliva. Improvements thus would be desirable in the field of animal bowls used for travel.

### SUMMARY

It has been found that improved pet feeing apparatuses are desired. An improved pet feeding apparatus in one embodiment includes an enclosure, a bowl and a container. The enclosure has a first portion and a second portion, is movable between a closed state and an open state, and has an interior region disposed generally between the first and second portions in the closed state. The bowl is disposed within the interior region and configured to be movable between a collapsed configuration when the enclosure is in the closed state and a deployed configuration when the enclosure is in the open state. The container is affixed to the first portion and having an internal region configured to retain material therein, the container having an opening that is in communication with the storage region, the container being movable between a first state that permits material to be received through the opening and a second state that resists movement of the material through the opening. The bowl and the container are disposed within the interior region when the enclosure is in the closed state.

In another embodiment, an improved pet feeding apparatus includes an enclosure, and first and second bowls. The enclosure has a first portion and a second portion, is movable between a closed state and an open state, and has an interior region disposed generally between the first and second portions in the closed state. The first and second bowls are disposed within the interior region, each of the first and second bowls being movable between collapsed configuration when the enclosure is in the closed state and a deployed configuration when the enclosure is in the open state. The first bowl is removably affixed to the first portion, and the second bowl is removably affixed to the second portion. The first and second bowls are disposed within the interior region when the enclosure is in the closed state.

### BRIEF DESCRIPTION OF THE DRAWINGS

Referring now to the attached drawings which form a part of this original disclosure:

FIG. 1 is a top perspective view of a pet feeding apparatus in a closed according to an embodiment;

FIG. 2 is a top perspective view of the pet feeding apparatus of FIG. 1 in an open state;

FIG. 3 is a top perspective of the pet feeding apparatus of FIG. 2 with the bowls in a deployed position;

FIG. 4 is a top perspective of the pet feeding apparatus of FIG. 3 with the bowls removed;

FIG. 5 is enlarged partial top perspective of the pet feeding apparatus of FIG. 4;

FIG. 6 is a top perspective view of a pet feeding apparatus in a closed according to another embodiment;

FIG. 7 is a top perspective view of the pet feeding apparatus of FIG. 6 in an open state;

FIG. 8 is a top perspective of the pet feeding apparatus of FIG. 7 with the bowl in a deployed position and the container in an open or unrestricted state;

FIG. 9 is a top perspective of the pet feeding apparatus of FIG. 8 with the bowl removed; and

FIG. 10 is a top perspective of the pet feeding apparatus of FIG. 8 with the container opened and an object disposed therein.

### DETAILED DESCRIPTION OF EMBODIMENTS

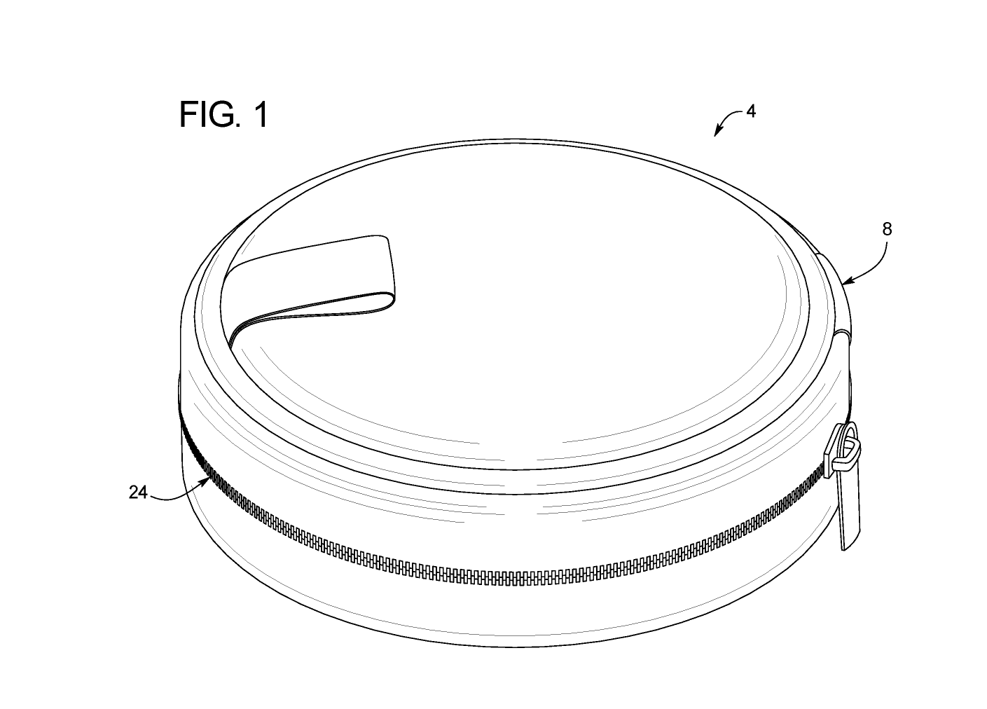

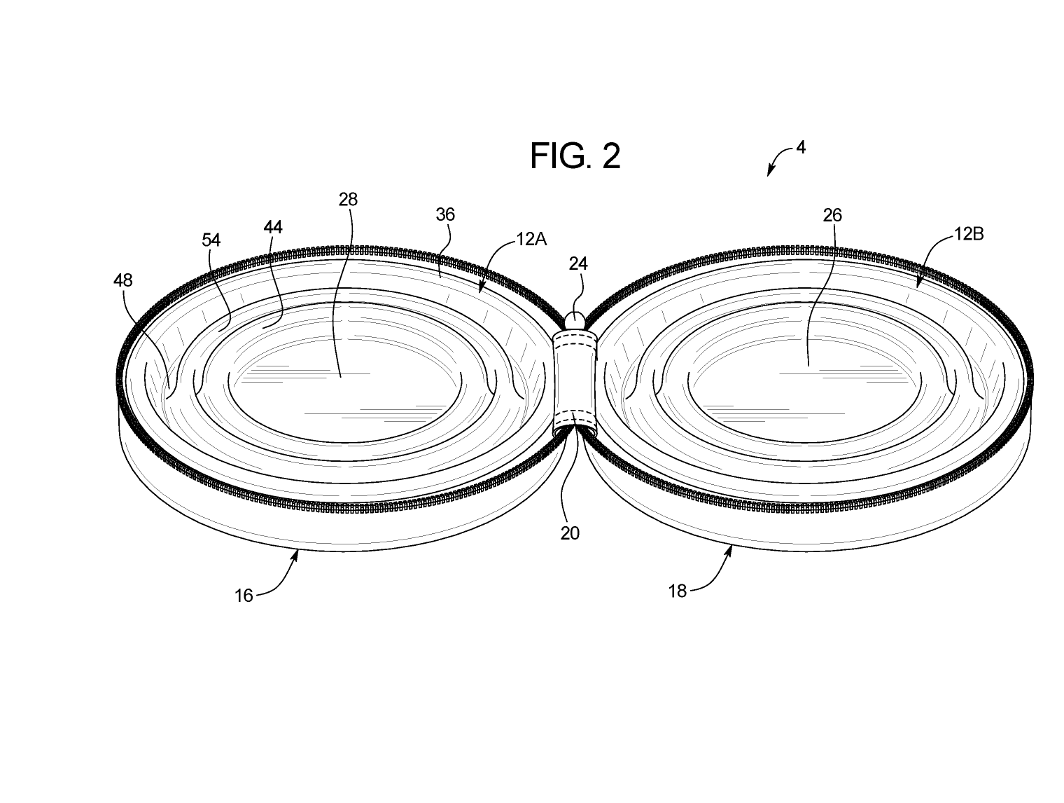

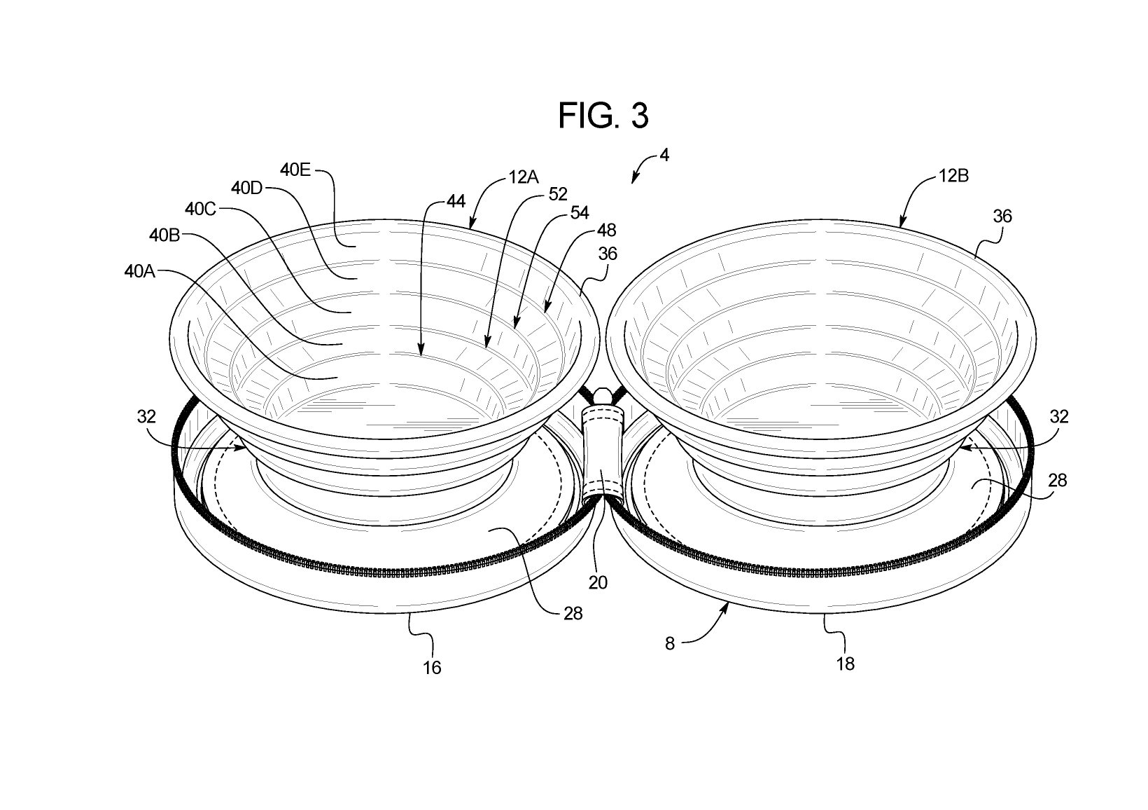

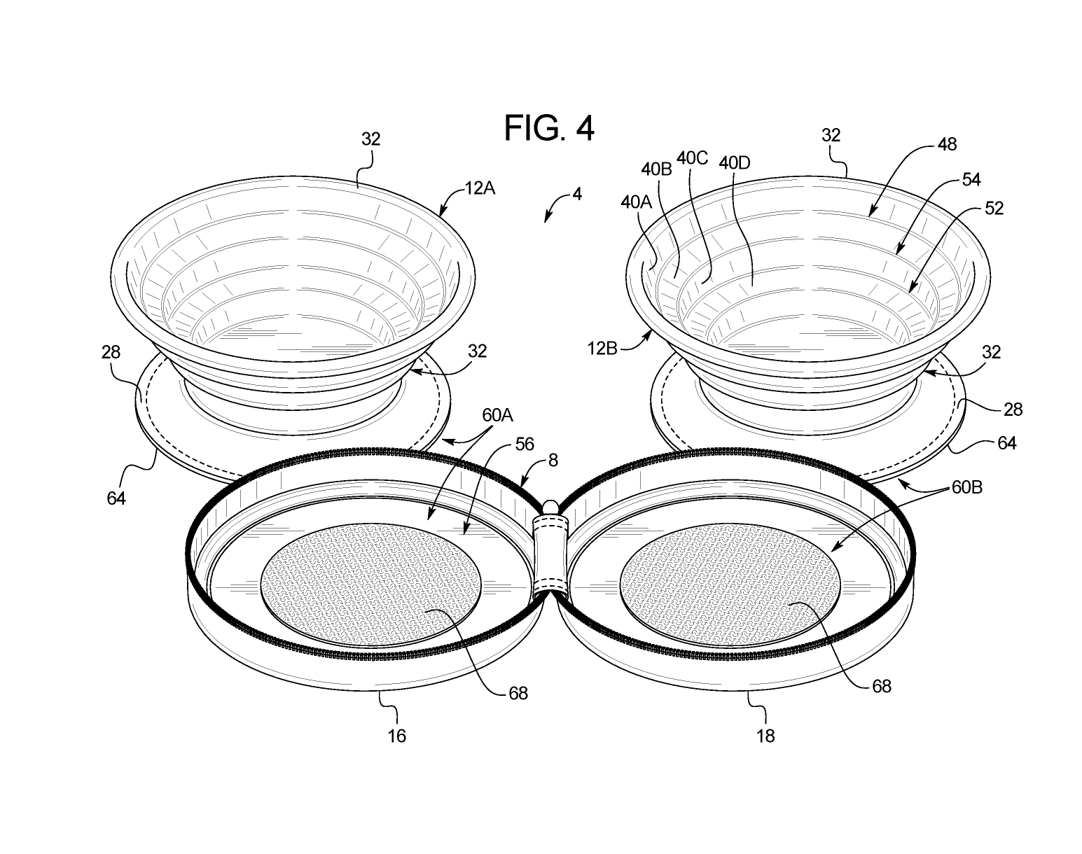

An improved pet feeding apparatus 4 in accordance with the disclosed and claimed concept is depicted in FIGS. 1-5. The pet feeding apparatus 4 generally includes an enclosure 8 and a pair of food bowls 12A and 12B. It is noted that the bowls 12A and 12B are, in the depicted exemplary embodiment, identical to one another and may be individually and/or collectively referred to herein with the numeral 12. However, food bowls 12A and 12B do not necessarily need to be identical.

The enclosure 8 includes a first portion 16 and a second portion 18 that are connected together with a flexible connection (connector) 20 that is disposed generally between the first and second portions 16 and 18. The enclosure 8 is movable between a closed state and an open state. The enclosure 8 includes a zipper (closing mechanism) 24 that is operable to retain the first and second portions fully attached to one another and to place the enclosure 8 in a closed state. The zipper 24 can be opened to allow the first and second portions 16 and 18 to be moved away from one another to place the enclosure 8 in its open state wherein the first and second portions 16 and 18 are partially detached from one another but remain connected together with the connection 20.

The enclosure 8 can include an interior region 26 which, in the state of the enclosure 8, is situated generally between the first and second portions 16 and 18. The bowls 12 are retained within the interior region 26 when the enclosure 8 is in its closed state.

The bowls 12 are each movable between a collapsed configuration and a deployed configuration when the enclosure 8 is in its open state. The bowls 12 are each in the collapsed configuration when the enclosure 8 is in its closed state. In the depicted exemplary embodiment, the enclosure 8 is formed largely of fabric or other flexible and durable materials, although other materials can be employed without departing from the present concept.

The bowls 12 each include a base 28, a lateral wall 32, and a rim 36 that is situated on the lateral wall 32 opposite the base 28. The bowls 12 are formed of a flexible, resilient elastomeric material such as a silicone rubber compound or other such material. The lateral wall 32 includes a plurality of corrugation legs that may be individually and/or collectively referred to herein with the numeral 40 that are situated generally between the base 28 and the rim 36. The corrugation legs 40 include a corrugation leg 40A connected with the base 28. Another corrugation leg 40B extends from the corrugation leg 40A at the end therefore opposite the base 28, and additional corrugation legs 40C, 40D, and 40E sequentially extend between the corrugation leg 40B and the rim 36.

The corrugation legs 40 are configured to be elastically deformable when the bowl 12 is moved between the collapsed and deployed configurations. More specifically, the corrugation legs 40 can generally retain the bowl 12 in the collapsed configuration or in the deployed configuration (or in a partially collapsed configuration) based upon the generalized structural and elastic properties of the material from which the bowl is made. The bowl 12 is moved from one such configuration to another by elastically deforming one or more of the legs 40 to each move between a first position and a second position. When all of the corrugation legs 40 are in the first position, the bowl 12 is in the collapsed configuration. When all of the corrugation legs 40 are in the second position, the bowl 12 is in the deployed configuration. When some of the corrugation legs 40 are in the first position and other corrugation legs 40 are in the second position, the bowl 12 is in a partially collapsed configuration that is not expressly depicted herein.

Each of the corrugation legs 40 is elastically movable with respect to each corrugation leg 40 that is adjacent thereto. As such, each adjacent pair of the corrugation legs 40 can be said to together from a corrugation in the lateral wall 32. For example, the corrugation legs 40A and 40B can together form a lower corrugation 44, and the corrugation legs 40D and 40E can form an upper corrugation 48. Moreover, the adjacent corrugation legs 40B and 40C can be said to together form a lower middle corrugation 52, and the corrugation legs 40C and 40D can likewise be said to together form an upper middle corrugation 54. It thus can be seen that the corrugation legs 40 are cooperable with one another to form a plurality of elastically deformable corrugations that enable the bowl 12 to be movable between the collapsed and deployed configurations.

The enclosure 8 further includes a fastening apparatus 56 that can include two sets of hook-and-loop fasteners 60A and 60B that releasably affix the bowls 12A and 12B to the first and second portions 16 and 18, respectively. The hook-and-loop fasteners 60A and 608 each include a first component 64, and the first components are affixed to the bases 28 of the bowls 12. The hook-and-loop fasteners 60A and 608 each further include a second component 68 that is releasably affixable to the first component 64 in a well-known fashion. The second components 68 are affixed to the interior surfaces of the first and second portions 16 and 18. It thus can be seen that the hook-and-loop fasteners 60A and 60B enable the bowls 12A and 12B to be affixed to the first and second portions 16 and 18, respectively, and further permit the bowls 12A and 128 to be detached from the enclosure 8 and placed on another supporting surface for feeding and/or watering an animal.

It can be understood from the accompanying figures that the first portion 16 has a first recess 72 within which the bowl 12A is situated when in the collapsed configuration and when the first and second components 64 and 68 of the hook-and-loop fastener 60A are attached to one another. It can further be seen that the second portion 18 includes a second recess 76 within which the bowl 12B is situated when in the collapsed configuration and when the first and second components 64 and 68 of the hook-and-loop fastener 60B are connected together. The first and second recesses 72 and 76 thus together form the interior region 26 when the enclosure 8 is in its closed state. Moreover, the first and second recesses 72 and 76 are sized to receive the bowls 12A and 12B, respectively, therein with minimal clearance between the bowls 12 and the enclosure 8, whereby the first and second recesses 72 and 76 serve to align and position the bowls 12 on the enclosure 8 preparatory to moving the enclosure 8 from its open state to its closed state.

It thus can be seen that the enclosure 8 with its zipper 24 operably extending between the first and second portions 16 and 18 retains the bowls 12 within the interior region 26 in a relatively compact configuration since the bowls 12 are in their collapsed configuration when the enclosure is in its closed state. Any food or water residue or saliva that may be situated on the bowls 12 is retained within the interior region 26 and thus advantageously avoids contamination of other items. Other advantages will be apparent.

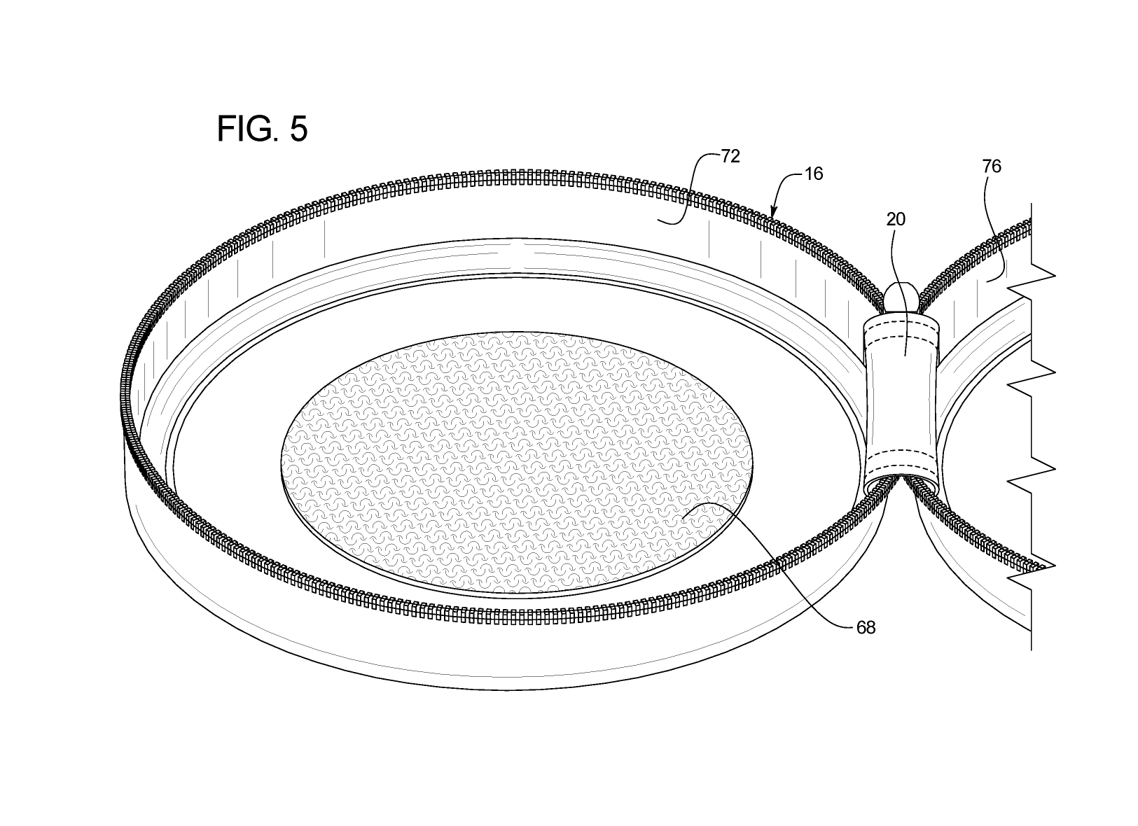

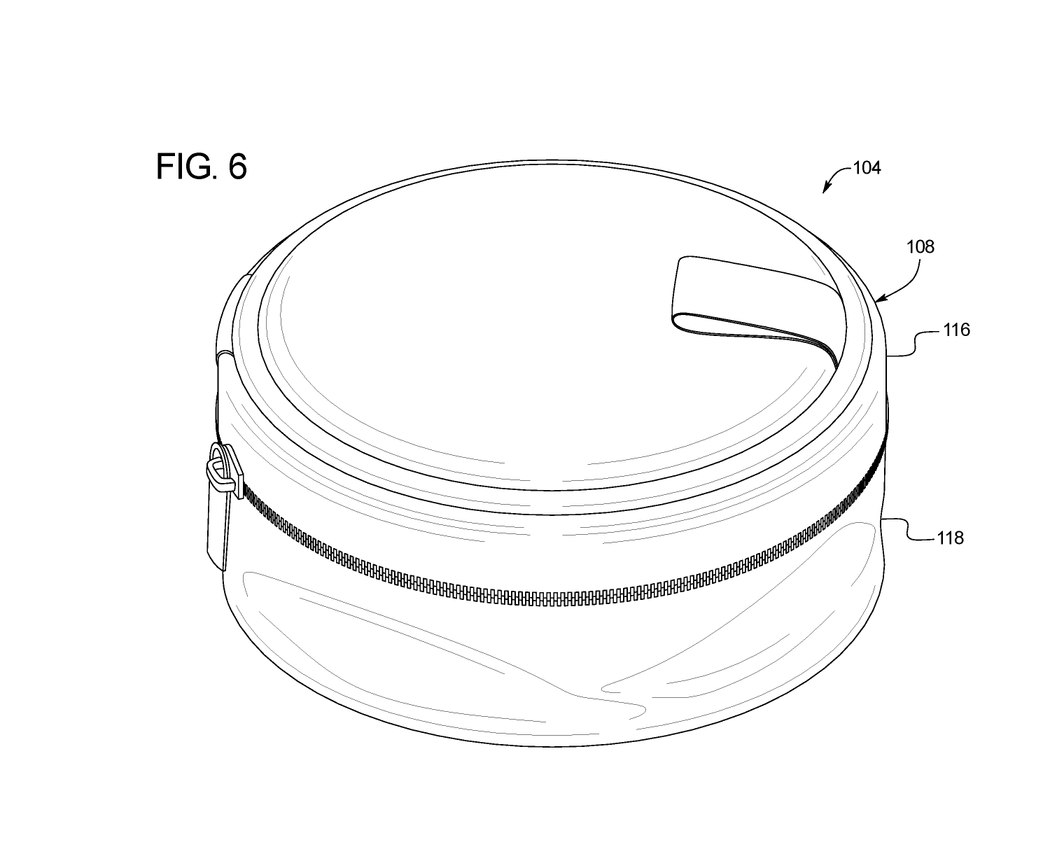

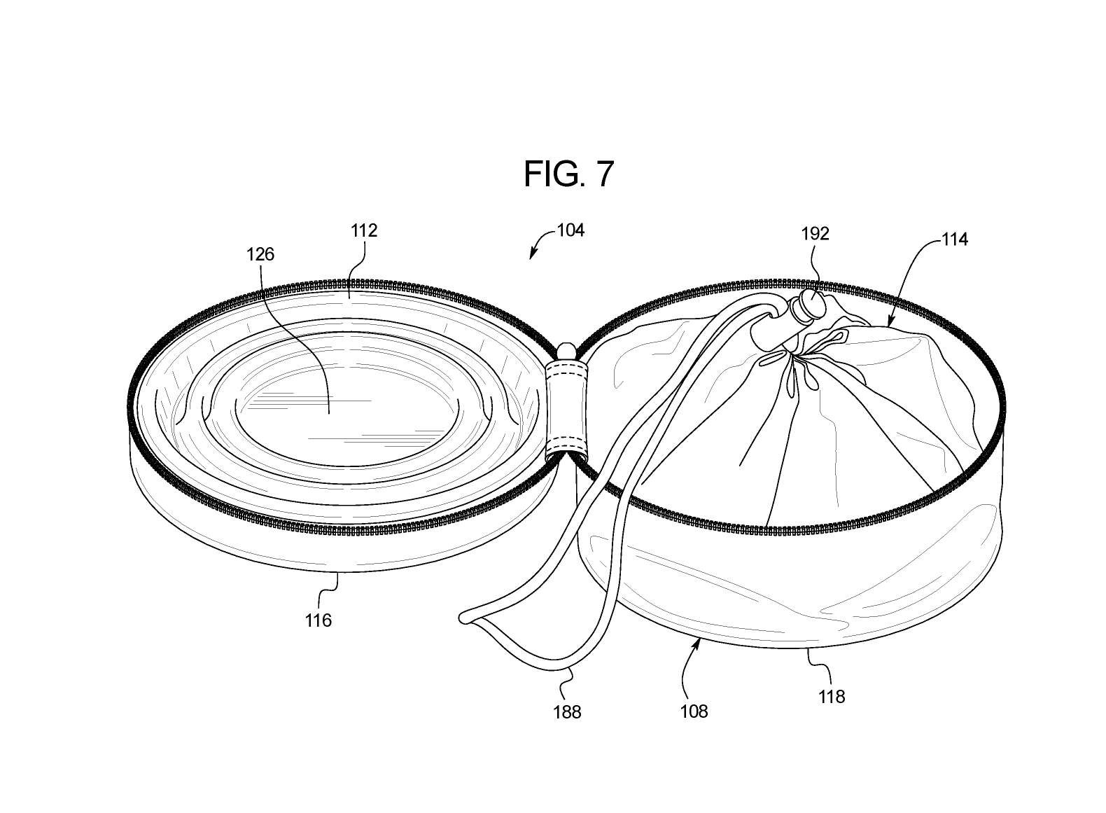

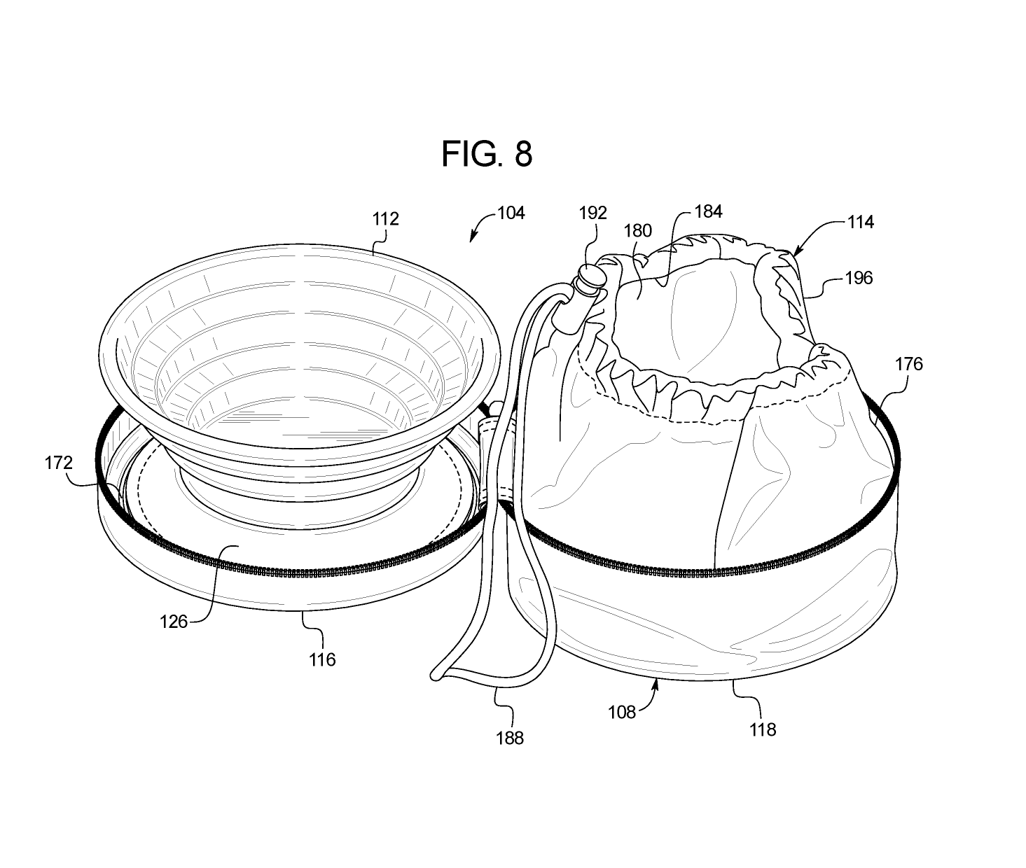

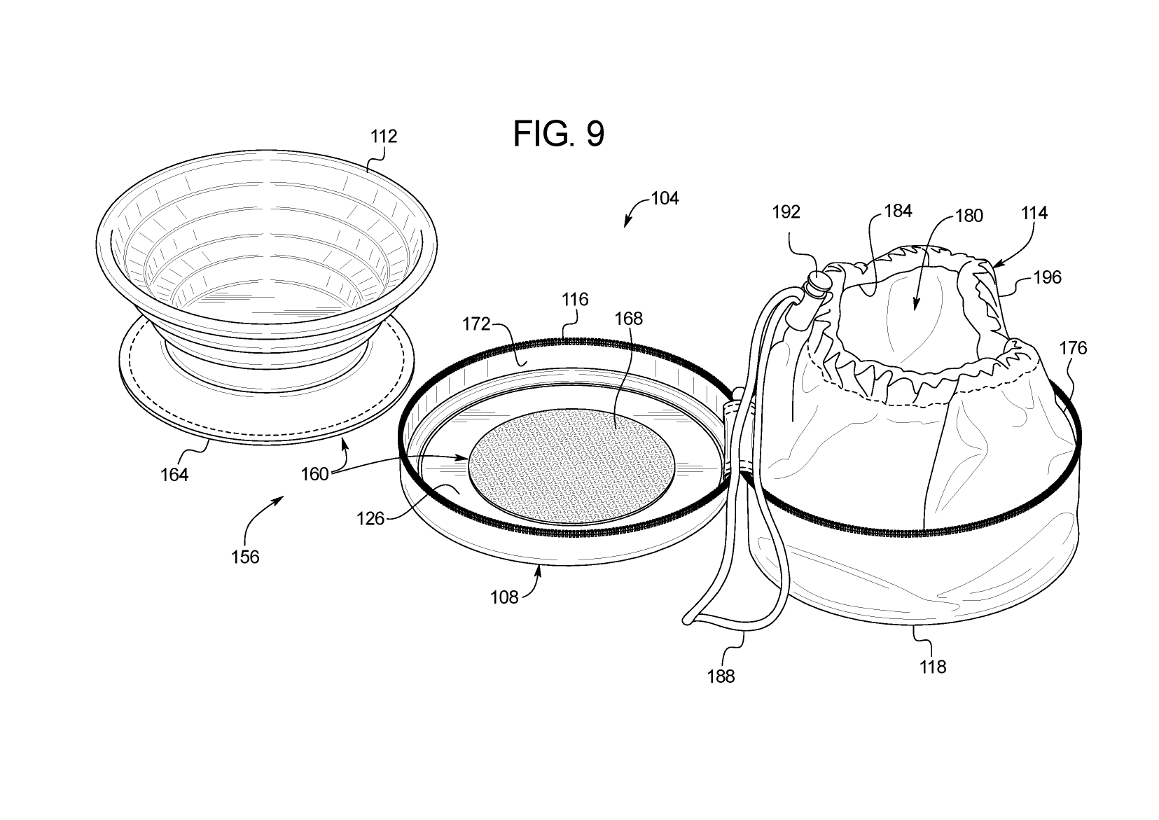

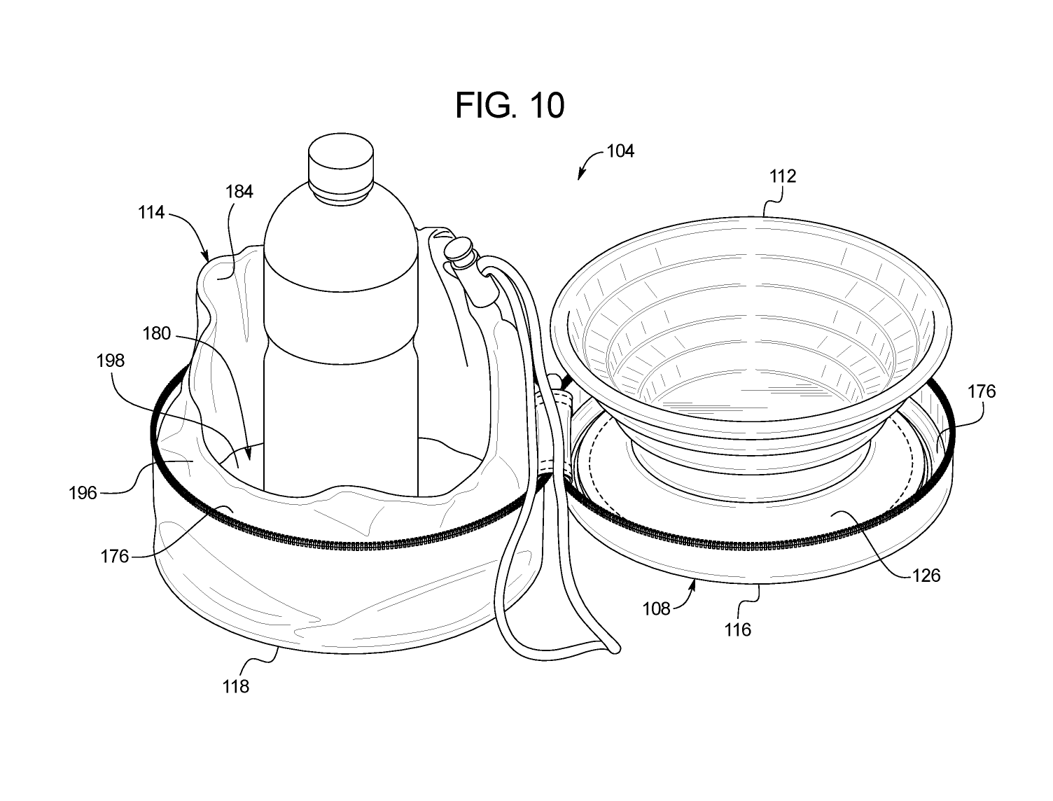

An improved pet feeding apparatus 104 in accordance with another embodiment of the disclosed and claimed concept is described herein and is depicted in FIGS. 5-10. The pet feeding apparatus 104 is similar to the pet feeding apparatus 4 in that it includes an enclosure 108 that is formed of first and second portions 116 and 118, respectively and that has an interior region 126 within which a bowl 112 is situated when the enclosure 108 is in its closed state. The bowl 112 is detachably affixed to the first portion 116 with a fastening apparatus 156 that includes a hook-and-loop fastener 160 having one component 164 therereof attached to the bowl 112 and another component 168 thereof attached to an interior surface of the first portion 116. However, the pet feeding apparatus 104 additionally includes a container 114 that is attached to the second portion 118 and that is configured to carry therein animal foodstuffs and the like and to enable such animal foodstuffs to be stored, transported, and dispensed into the bowl 112.

The container 114 in the depicted exemplary embodiment is an approximately bag-shaped fabric construction. The enclosure 108 includes a first recess 172 situated on first portion 116 within which the bowl 112 is situated when affixed to the first portion 116. The enclosure 108 further includes a second recess 176 on the second portion 118 within which the container 114 is situated. The interior region 126 is situated generally between the first and second recesses 172 and 176 when the pet feeding apparatus 104 is in its closed state.

The container 114 is generally hollow and has a storage region 180 internal thereto within which the animal foodstuffs can be stored. The container 114 additionally opening 184 that is situated adjacent and is in communication with the storage region 180. The opening is movable between a generally closed state wherein the animal foodstuffs (objects or material) are retained within the storage region 180 and a generally open state wherein animal foodstuffs can be through the opening 184 and into or out of the storage region 180. In this regard, it can be seen that the container 114 includes a drawstring 188 that extends generally about the opening 184 and a clamp 192 that is situated on the drawstring 188. In a well-understood fashion, the drawstring 188 can be manually pulled and thus partially removed from its sewn passage on the container 114 to cause the opening 184 to move to its generally closed state, and the clamp 192 can be moved and released at a location where it retains the drawstring 188 in such a position. Thereafter, the clamp 192 can be released and the drawstring 188 permitted to return into its passage to cause the opening 184 to be moved to the generally open state.

The container 114 can be additionally include a sidewall 196 and a bottom 198 that are connected together. The sidewall 196 and the bottom 198 in the depicted exemplary embodiment are formed from a plastic-coated fabric that is generally impervious to flow of gas and/or liquid therethrough and that helps to maintain the animal foodstuffs in a generally fresh condition. In contrast, the enclosure 108 is typically formed of a high density fabric that is not necessarily plastic coated. The sidewall 196 and the bottom 198 are connected together, such as by sewing, or are formed from a single piece of material, and either or both of the sidewall 196 and the bottom 198 are affixed to the second portion 118 via sewing or other appropriate methodology. Alternatively, the container 114 can be removably affixed to the second portion 118 through the use of another hook-and-loop fastener.

In the fully open state, it can be seen that the sidewall 196 extends a significant distance beyond the zippered edge of the second portion 118. This is to enable the sidewall 196 in the closed position of the opening 184 to reach generally the central region of the enclosure 108, thereby enabling the opening 184 to be very small to retain the animal foodstuffs therein and to minimize airflow through the opening 184 in the closed state.

Depending upon the material used for the container 114, the container 114 potentially can be used for holding water in the open state of the enclosure 108 and when the second portion 118 is placed upon an approximately horizontal support. That is, the container 114 could initially be filled with animal foodstuffs and the opening 184 closed with the drawstring 188. The enclosure 108 could then be moved to its closed state once the bowl 112 is situated in its collapsed configuration. At the animal's feeding time, the enclosure 108 can be moved to its open state, and the clamp 192 and the drawstring 188 can be operated to move the opening 184 to its open state. The animal foodstuffs that are situated in the storage region 180 can then be poured into the bowl 112 once the bowl 112 has been moved to its deployed configuration. Water can then be poured into the now empty storage region 180, and the container 112 can thus retain the water therein for watering of the animal.

When the animal is finished, excess water can be drained from the storage region 180, and the enclosure 108 can be returned to its closed state. Since the animal foodstuffs that had been situated in the storage region 180 have been removed therefrom and have been fed to the animal, the flexibility of the fabric that forms the second portion 118 permits the second portion 118 to at least partially collapse in the absence of such animal foodstuffs, thereby permitting the pet feeding apparatus 104 to have an even smaller profile when empty.

In order to receive and hold water in the container 114 in the open state, the sidewall 196 and the bottom 198 will desirably be of a liquid-impervious material. Moreover, it can be understood that the container 114 could be alternatively configured so that its opening is moved between open and closed states by structures other than the drawstring 188 and the clamp 192 described herein. As an example, the container 114 could be configured to be more in the nature of a fresh food storage container having a removable and sealable lid but that is tailored to be situated in the second recess 176. Other variations will be apparent.

While specific embodiments of the disclosed concept have been described in detail, it will be appreciated by those skilled in the art that various modifications and alternatives to those details could be developed in light of the overall teachings of the disclosure. Accordingly, the particular arrangement disclosed are meant to be illustrative only and not limiting as to the scope of the disclosed concept which is to be given the full breadth of the claims appended and any and all equivalents thereof.

What is claimed is:

1. A pet feeding apparatus comprising:
an enclosure having a first portion and a second portion, being movable between a closed state and an open state, and having an interior region disposed generally between the first and second portions in the closed state;
a bowl disposed within the interior region and configured to be movable between a collapsed configuration when the enclosure is in the closed state and a deployed configuration when the enclosure is in the open state; and
a container affixed to the first portion and having an internal region configured to retain a object therein, the container having an opening that is in communication with the storage region, the container being movable between a first state that permits the object to be received through the opening and a second state that resists movement of the object through the opening,
the bowl and the container being disposed within the interior region when the enclosure is in the closed state.

2. The pet feeding apparatus of claim 1, wherein
the bowl is removably affixed to the second portion.

3. The pet feeding apparatus of claim 1, further comprising
a connector is disposed between the first and second portions.

4. The pet feeding apparatus of claim 1, wherein
the bowl includes a plurality of corrugation legs.

5. The pet feeding apparatus of claim 1, wherein
the container includes a drawstring and a clamp configured to resist movement of the object through the opening in the second state.

6. The pet feeding apparatus of claim 1, further comprising
a closing mechanism configured to couple the first and second portions to one another to place the enclosure in the closed state.

7. The pet feeding apparatus of claim 6, wherein
the closing mechanism is a zipper.

8. The pet feeding apparatus of claim 1, further comprising
a fastening apparatus configured to releasably affix the bowl to the second portion.

9. The pet feeding apparatus of claim 8, wherein
the fastening apparatus is a hook-and-loop fastener.

10. A pet feeding apparatus comprising:
an enclosure having a first portion and a second portion, being movable between a closed state and an open state, and having an interior region disposed generally between the first and second portions in the closed state; and
first and second bowls disposed within the interior region, each of the first and second bowls being movable between collapsed configuration when the enclosure is in the closed state and a deployed configuration when the enclosure is in the open state,
the first bowl being removably affixed to the first portion, and the second bowl being removably affixed to the second portion, and
the first and second bowls being disposed within the interior region when the enclosure is in the closed state.

11. The pet feeding apparatus of claim 10, wherein
the first and second bowls are removably affixed to the first and second portions.

12. The pet feeding apparatus of claim 10, further comprising
a connector is disposed between the first and second portions.

13. The pet feeding apparatus of claim 10, wherein
each of the first and second bowls includes a plurality of corrugation legs.

14. The pet feeding apparatus of claim 10, further comprising
a closing mechanism configured to couple the first and second portions to one another to place the enclosure in the closed state.

15. The pet feeding apparatus of claim 14, wherein
the closing mechanism is a zipper.

16. The pet feeding apparatus of claim 10, further comprising
a fastening apparatus configured to releasably affix the bowl to the second portion.

17. The pet feeding apparatus of claim 16, wherein
the fastening apparatus is a hook-and-loop fastener.
